(19) United States
(12) Patent Application Publication
(10) Pub. No.: US 2013/0310971 A1
(43) Pub. Date: Nov. 21, 2013

(54) Robotic Construction Site Marking Apparatus

(71) Applicant: Joseph M. Prouty, Chula Vista, CA (US)

(72) Inventor: Joseph M. Prouty, Chula Vista, CA (US)

(21) Appl. No.: 13/471,883

(22) Filed: May 15, 2012

(51) Int. Cl. G06F 19/00

(52) U.S. Cl. 700/245; 901/43; 901/1

(57) ABSTRACT

A position location and marking system includes a base unit having stored data location files and communication apparatus therein together with a cooperating mobile element which communicates with and aides in location under the control of the base unit. A robotic marker is provided with battery-powered self-propulsion and directional control and receives and supports the mobile element of the positioning system. A sprayer is also supported upon the robotic marker and is maintained in alignment with the position detecting portion of the mobile unit by a gimble system. An onboard controller is also supported upon the robotic marker to control robotic movements and spray operation in response to communicative position and location data.

### FIELD OF THE INVENTION

This invention relates generally to methods and apparatus for transferring plan information to construction sites and relates particularly to apparatus and methods for establishing reference positions upon the floor portions of construction sites.

### BACKGROUND OF THE INVENTION

In most building construction, a detailed plan is initially created which provides a series of drawings setting forth the dimensions and character of the building to be constructed. Additional information is found in such drawings or plans which establishes other critical information such as location of exterior and interior walls, location of facilities such as plumbing and ventilation and other structural information such as the locations of doors, windows and stairways. Historically, such building plans were known generally as “blue prints” deriving their name from the blue on white printing systems used in their creation.

While the construction methods utilized in various buildings is subject to substantial variation, typically one or more concrete floors are poured and formed as a building base. Often the concrete floors house various elements such as plumbing pipework, conduits, and drains many of which travel beneath or through the poured concrete floor. In most building construction, the first floor concrete is allowed to cure to a sufficient extent to provide strength and stable physical dimensions. Thereafter, the concrete floor is marked with a plurality of reference points which establish the critical locations of building elements such as walls or the like. This marking process is, in essence, a process of transferring a portion of the plan information from the building plans to the concrete surface. For many years, the basic approach for marking this layout and reference information upon the concrete floor surface employed a manual process. The prints and plans were viewed and understood by one or more operators who utilized a number of measurements to transfer the information from the plans to the concrete floor. In many instances, additional apparatus such as chalk lines or the like were utilized to establish connecting lines between reference points such as connecting straight line wall contours between corner positions. In addition, some systems employed surveyors instruments to establish critical location points upon the concrete floor.

With the development of complex and evermore capable digital information systems, practitioner's in the art began utilizing computer generator plans for building design rather than the previously established blue print type plans. In such systems, the plan information is created in accordance with a design software which then stores the plan information in digital file form. Once created as digital files, even the most complex plans and extensive building designs may be processed, transferred, stored and transported with great efficiency as digital data. As technology advanced and capabilities of ever smaller computing systems evolved, such building plans were easily storable and transferrable within handheld communication devices. This advance provided substantial improvement in the efficiency of the construction layout process in that the entire building plan set was easily transportable to the build site. As the build site, operators were able to utilize the plans employing the handheld digital devices by virtue of the display screens which such devices provided.

Perhaps one of the most popular and effective electronic layout systems currently employed is the TRIMBLE MEP system sold by TRIMBLE INCORPORATED. Systems such as the TRIMBLE MEP system make use of the recent developments in digital electronic systems which facilitate the position locationing of one element of a communication system relative to a base system unit. Thus, system such the TRIMBLE MEP system provide a base unit which stores plan layout information within an internal memory. The base unit is positioned at a reference point previously established in the plan information. The base unit includes positioning and locating systems. The system also includes a prism pole which in turn supports a prism reflector. The system further includes a handheld PDA unit which includes a substantial memory for storing plan information together with communication apparatus constructed to communicate with the base unit in bi-directional communication. The positioning and location system within the base unit is operative to determine the current position of the prism reflector. The base unit communicates location information of the prism reflector relative to the base unit.

In operation, the base unit is positioned at a reference point previously established within the building plans. An operator, often called the marker, carries the prism pole and PDA while walking upon the concrete building floor. As the marker moves about the concrete floor, the position of the prism reflector on the prism pole carried by the marker is tracked and compared to a to-be-marked reference point within the stored plan. The base unit communicates direction information to the PDA unit aiding the marker in reaching the to-be-marked reference point. When the marker carries the handheld unit to the to-be-marked reference point, the base unit confirms the location to the PDA unit and gives the marker confirmation of correct positioning. The marker then marks the location of the reference point upon the concrete. For the most part, the marker typically employs a conventional ink marker, paint marker or the like in establishing reference marks. This process is repeated for the required number of reference points to be established upon the concrete floor of the building. In some instances, reference points are connected by lines utilizing conventional apparatus such as chalk lines or the like. One example of such chalk line use is the creation of wall perimeter sections between reference points.

While systems such as the foregoing described system have enjoyed some success, the use of operators to provide manual positioning and movement of the handheld unit and to mark reference points upon the concrete surface requires and additional operator. Also, the use of a manual positioning operator often subjects the marking system to errors and inconsistencies.

In technologies generally related to the present invention, U.S. Pat. No. 5,671,160 issued to Julian sets forth a POSITION SENSING SYSTEM for three-dimensional position sensing including a target station, a reference station and a means for accurately calculating the position of the target station relative to the reference station. The system includes the use of at least one gyroscope and a computer to determine the position of the target station. The system may be used for land surveying, earth grading, and marine navigation.

In technologies also related generally to the present invention, practitioners in the art have developed various robotic devices such as US Published Patent Application US2009/0228166 filed on behalf of Durkos et al which sets forth a ROBOTIC VEHICLE CONTROLLER providing a system for automatically moving a robotic machine along a desired path. The device is self contained and mobile and includes communication and control apparatus.

U.S. Pat. No. 5,990,809 issued to Howard sets forth an UNDERWATER SURVEYING SYSTEM utilized in surveying the bottom of a shallow body of water having a submersible remotely-controlled self-powered vehicle. The vehicle includes a chassis, a drive mechanism, a drive control module to direct the movement of the vehicle and a mast extending upwardly from the chassis supporting an antenna on the upper portion. Control signals are transmitted from land to the vehicle via the antenna to control movement.

U.S. Pat. No. 4,137,638 issued to Watts sets forth an ELECTROMECHANICAL SURVEY VEHICLE AND METHOD having a multi-wheeled articulated chassis supporting a plurality of rolling wheels and a plurality of position encoders. The movement of the articulated elements of the vehicle is sensed by the plurality of encoders as the vehicle moves providing contour information for the terrain across which the vehicle travels.

U.S. Pat. No. 7,066,276 issued to Wilcox sets forth a METHOD AND APPARATUS FOR EVACUATING EARTH TO A DESIRED DEPTH which includes a robotic self-propelled vehicle having remotely controlled movement apparatus. The vehicle supports an extending mast which includes visual elements utilized in determining the depth of the surface upon which the vehicle is moving. Line of sight visualization of the position of the mast supported visible elements provides depth information.

U.S. Pat. No. D437,255 issued to Bickler et al sets forth a design for a mars rover. The mars rover is self-powered and controlled by control information supplied remotely as the vehicle is deployed upon a remote surface such as the planet Mars or the like.

Despite substantial advances in the arts related to construction site marking and the transfer of plan information, there remains nonetheless a continuing need in the art for ever more improved, effective, and efficient marking systems.

### SUMMARY OF THE INVENTION

Accordingly, it is a general object of the present invention to provide an improved construction site marking apparatus. It is a more particular object of the present invention to provide an improved construction site marking apparatus which avoids the need for an operator to carry the moveable element in a site marking system.

In accordance with the present invention, there is provided a robotic apparatus for construction site marking upon a floor surface, said robotic apparatus comprising: a base unit positionable at a reference point upon a floor surface having means for storing site layout information, location means and communication means; a movable position locator cooperating with the base unit in communication therewith; a robotic marker having a body, a plurality of drive wheels and a drive controller for operating the drive wheel to move the robotic marker upon a floor surface; a receptacle receiving a portion of the position locator; spray means having a sprayer and a spray nozzle; and a gimble support supporting the position locator and the sprayer such that the position locator and the spray nozzle are aligned along a common vertical axis, the base unit and the position locator cooperating to direct the robotic marker to move to one or more reference points upon a floor surface and to mark a floor at the one or more reference points by activating the sprayer.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a top view of a robotic construction site marking apparatus constructed in accordance with the present invention;

FIG. 2 sets forth a side elevation view of a robotic marking apparatus constructed in accordance with the present invention;

FIG. 3 sets forth a front view of the marking apparatus shown in FIG. 2;

FIG. 4 sets forth a section view of the robotic marking apparatus of the present invention taken along section lines 4-4 in FIG. 3;

FIG. 5 sets forth a partial perspective assembly view of the digital encoder and handheld unit of the present invention robotic marking device; and

FIG. 6 sets forth a flow diagram of the operation of the present invention robotic construction site marking apparatus.

### DESCRIPTION OF THE PREFERRED EMBODIMENT OF THE INVENTION

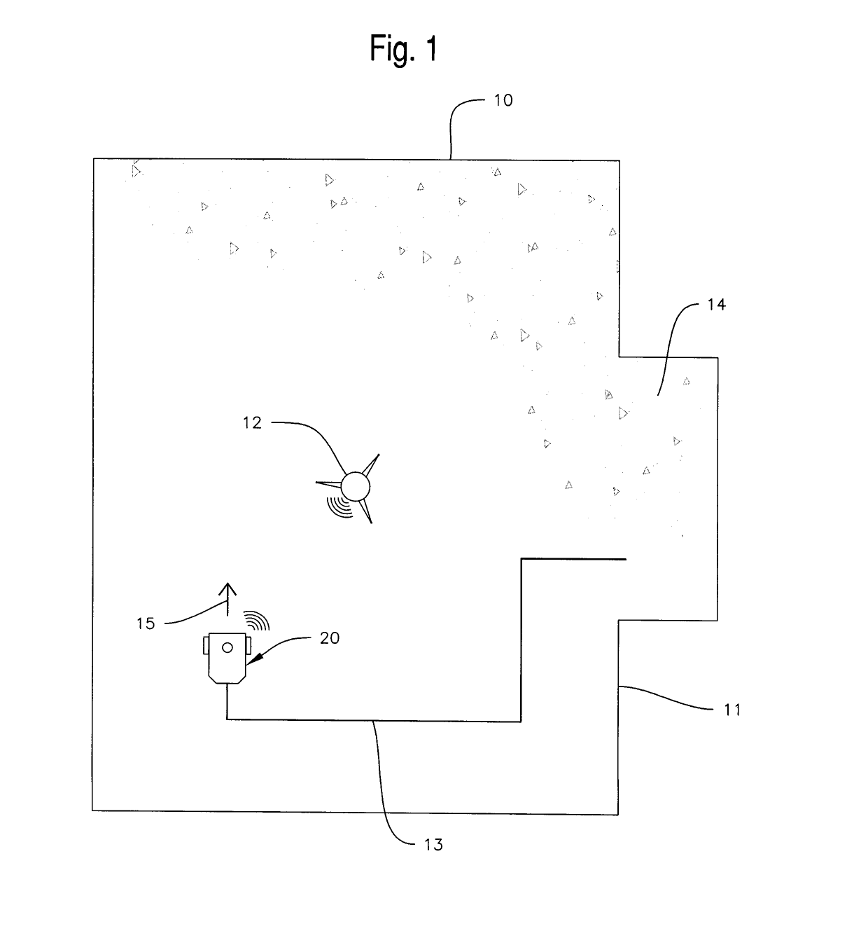

FIG. 1 sets forth a top plan view of an illustrative construction site having a robotic construction site marking apparatus in a typical operating environment. More specifically, FIG. 1 sets forth a concrete building floor 10 defining a generally planar surface 14 and an outer periphery 11. Concrete floor 12 is fabricated entirely in accordance with conventional fabrication techniques and is provided solely as an illustration of a construction site within which the present invention robotic construction site marking apparatus may be used. Thus, upon surface 14, a base unit 12 constructed in accordance with conventional fabrication techniques and described below in greater detail is situated upon surface 14 at a predetermined reference point. In accordance with the present invention, a robotic construction site marking apparatus generally referenced by numeral 20 is operative upon surface 14. In accordance with the fabrication set forth below in greater detail, robotic construction site marking apparatus 20 is in wireless communication with base 12 to establish a bidirectional data information communication link. By means set forth below in greater detail, robotic construction site marking apparatus 20 is moving upon surface 14 and is marking a reference line 13 as robotic marker 20 travels. Robotic marker 20 is, as set forth below in greater detail, independently self-propelled and thus moves upon surface 14 under the control of information provided by base unit 12. In the illustration of FIG. 1, robotic marker 20 is moving in the direction indicated by arrow 15 and is marking reference line 13 to define a wall contour and location upon surface 14. In accordance with the preferred fabrication and use of the present invention robotic construction site marking apparatus, robotic marker 20 may be utilized to mark a continuous contour line such as reference line 13 or may be directed to a specific location upon surface 13 and mark a reference point or location as desired.

In the preferred fabrication of the present invention, robotic marker 20 operates under the control of a base unit such as the base unit manufactured by TRIMBLE MEP which in turn is operated utilizing TRIMBLE field software. In further accordance with the preferred fabrication of the present invention and as is described below in greater detail, robotic marker 20 supports a handheld controller also preferably manufactured by TRIMBLE MEP. In accordance with the operation of the TRIMBLE MEP system and software, the TRIMBLE field software imports both 3D point data CAD files into the handheld controller for the location of various reference points and positions such as wall contours and utility apparatus locations. In accordance with the present invention and as is described below in greater detail, robotic marker 20 provides a self-propelled entirely self-sufficient battery powered robotic unit which utilizes the guidance and communication of the TRIMBLE MEP system to facilitate reference marking upon surface 14 of concrete floor 10 without the need for a marking operator. The system is fully self-contained and includes an onboard battery power supply together with differential directional drive apparatus or movement. As is also set forth below in greater detail, robotic marker 20 further includes a receptacle for supporting the handheld TRIMBLE MEP controller together with a spray marker in a gimble supported apparatus. The gimble supported unit is described below in greater detail. However, suffice it to note here that the gimble support of the spray marker and guidance unit apparatus maintains the required perpendicular vertical orientation of the sprayer and guidance unit necessary to maintain accuracy of marker placement. The battery-powered differential drive system utilized in robotic marker 20 may be constructed in accordance with conventional fabrication systems suitable for moving robotic marker 20 upon surface 14 to any desired location or through any desired path.

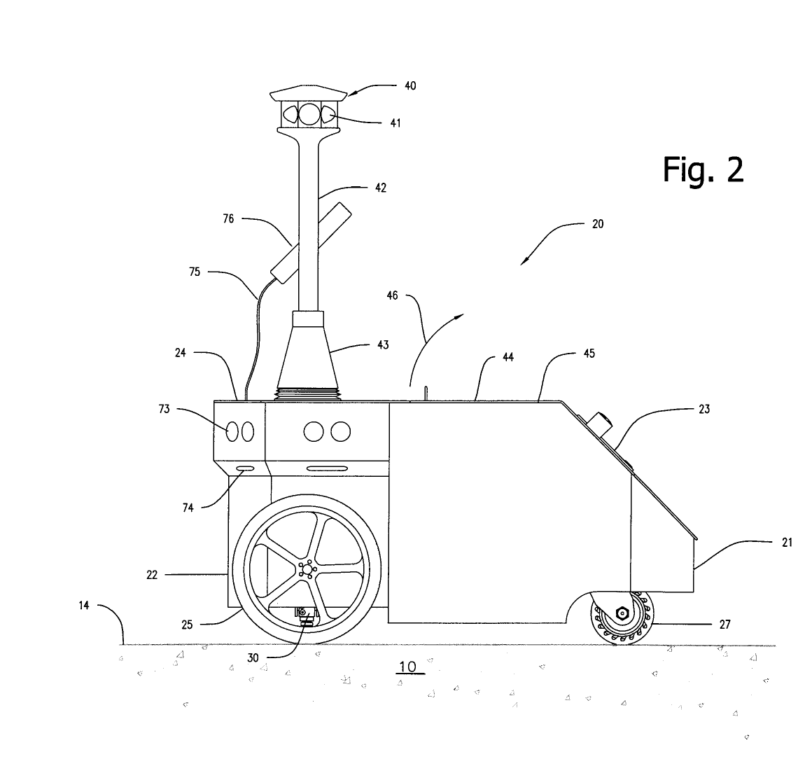

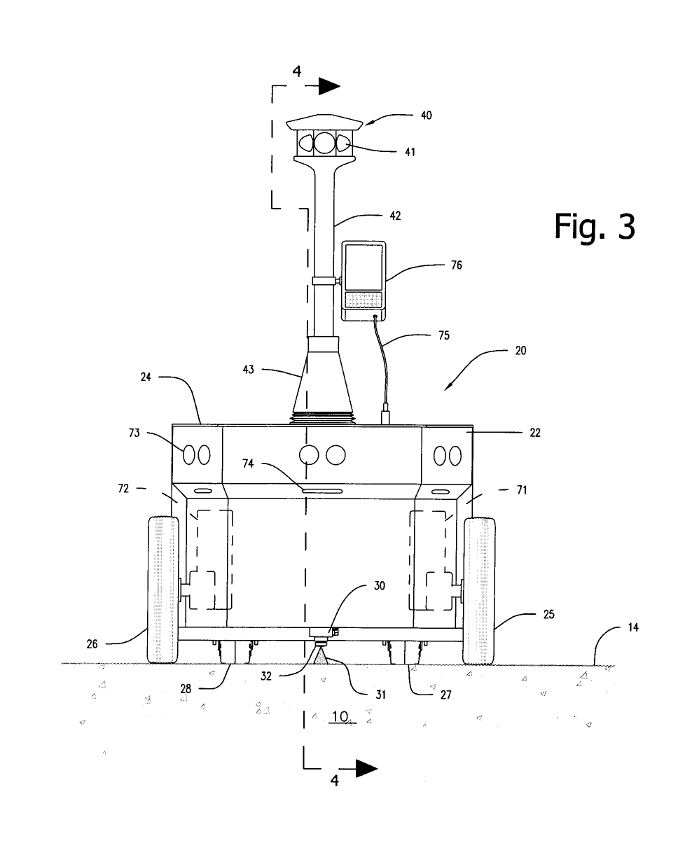

FIG. 2 set forth a side elevation view of a robotic construction site marking apparatus generally referenced by numeral 20. Apparatus 20 includes a body 21 fabricated of a strong rigid material such as steel, aluminum or composite materials. Body 21 defines a front portion 22 and a top surface 24. A control panel 23 is supported upon the rear portion of body 21. An access door 44 is supported upon top surface by a hinge 45. Apparatus 20 further includes a pair of drive wheels 25 and 26 (drive wheel 26 seen in FIG. 3). Apparatus 20 also includes a pair of casters 27 and 28 (caster 28 seen in FIG. 3) supported upon the rear portion of boy 21. As is described below, drive wheels 25 and 26 provide powered locomotion for movement of apparatus 20 and are operative under the control of a differential drive controller utilizing a battery power supply. Casters 27 and 28 provide support for the rear portion of apparatus 20 and are pivotally supported free-wheeling conventional casters. Thus, as is also described below in greater detail, the directional movement of apparatus 20 is controlled and implemented by differential rotation of drive wheels 25 and 26.

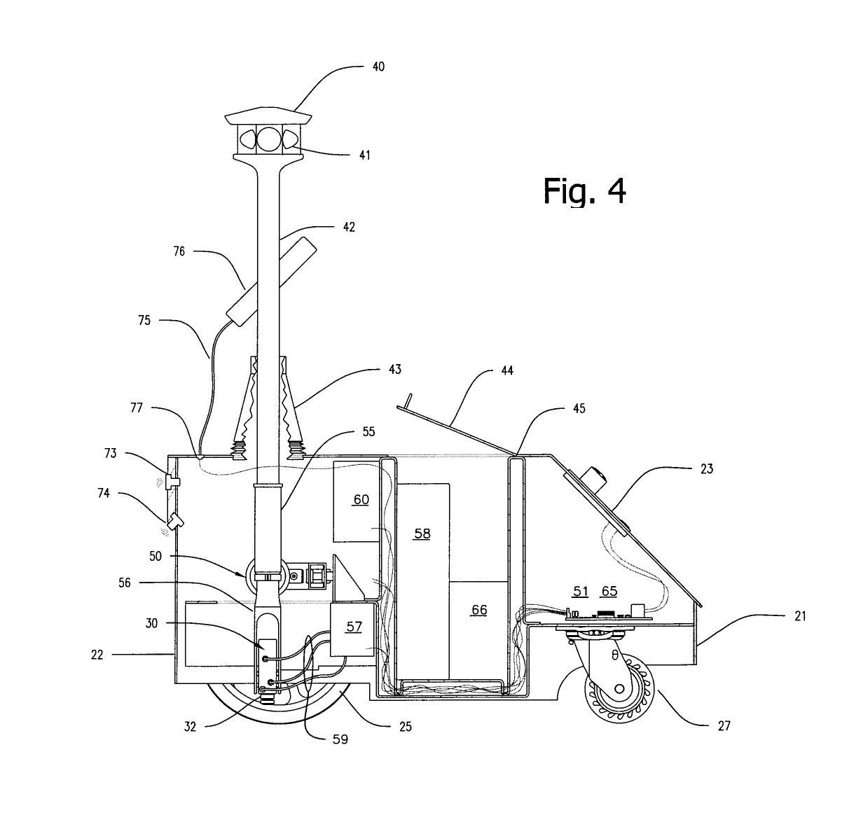

In accordance with an important aspect of the present invention, body 21 further includes apparatus for supporting a prism pole 40 constructed in accordance with the locating system operating in the manner described above. Thus, in the illustration of the present invention shown in FIG. 2, prism pole 40 cooperates with base unit 12 (seen in FIG. 1) to provide communication and location information. Prism pole 40 includes a prism reflection unit 41 supported by an elongated staff 42. As is set forth below in FIG. 3, prism pole 40 is supported upon apparatus 20 by the insertion of the lower portion of staff 42 within a staff receptacle 55. A flexible protective boot 43 is supported upon top surface 24 and receives of staff 42 extending therethrough. Boot 43 provides protection against dust and other contamination which would otherwise be capable of entering body 21. Apparatus 20 further includes a sprayer 30 which, as is better seen in FIG. 4, is supported in general alignment with staff 42 of prism pole 40. Sprayer 30 is operative under control of a spray controller 57 (seen in FIG. 4). Sprayer 30 provides the actual surface marking of reference information provided by the present invention robotic construction site marking apparatus.

FIG. 3 sets forth a front view of robotic construction site marking apparatus 20 supported upon surface 14 of concrete floor 10 (seen in FIG. 1). As described above, apparatus 20 includes a body 21 having a front portion 22 and a top surface 24. Body 21 further includes an access door 44 shown in FIG. 3 in a partially open position. As described above, access door 44 is pivotally secured to body 21 by a hinge 45 (seen in FIG. 2) and provides access to the interior of body 21.

Apparatus 20 further includes a pair of drive wheels 25 and 26 supported upon body 21 and operatively coupled to a pair of drive motors 71 and 72 respectively. Drive motors 71 and 72 are operative in accordance with conventional fabrication techniques to provide bi-directional differential rotational power to drive wheels 25 and 26 to facilitate movement and turning of apparatus 20 upon surface 14. As is also described above, apparatus 20 further supports a prism pull 40 having a prism reflector unit 41 on the upper end of a supporting staff 42. Staff 42 also supports PDA 76 and extends downwardly into body 21 and is protectively enclosed by a flexible boot 43 secured to upper surface 24. Cable 75 operatively couples PDA 76 to the control system within body 21 (seen in FIG. 4). As is set forth below in FIG. 4 in greater detail, staff 42 is operatively coupled to a receptacle which in turn is supported by a gimble support 50 (seen in FIG. 4). As is also better seen in FIG. 4, a sprayer 30 is supported beneath prism poll 40 and is directed downwardly toward surface 14. In operation, sprayer 30 produces a marking spray 31 which provides the actual reference marking of concrete floor surface 14. Spray 31 may utilize conventional paint or alternative marking inks as required for the particular construction site requirements. Apparatus 20 further includes a pair of casters 27 and 28 which are freely pivotable and are caster supported upon body 21. Casters 27 and 28 in essence, follow the directional movement of apparatus 20 implemented by the action of drive wheels 25 and 26. A sonar detector 73 and infrared detector 74 are also supported on front surface 22 of body 21.

FIG. 4 sets forth a section view of robotic construction site marking apparatus 20 taken along section lines 4-4 in FIG. 3. As described above, robotic apparatus 20 includes a body 21 supported by a pair of drive wheels 25 and 26 (drive wheel 26 seen in FIG. 3). Additionally, body 21 is supported by a pair of casters 27 and 28 (caster 28 seen in FIG. 3). Body 21 is preferably formed of a relatively strong rigid material such as steel, aluminum or suitable composite fiberglass material and forms a generally hollow body within which the operative apparatus used in robotic apparatus 20 is supported. Additionally, body 21 supports a control panel 23, an access door 44 which is pivotally secured by a hinge 45 and a top surface 24. A front portion 22 is also formed in body 21. A battery power supply 66 constructed in accordance with conventional fabrication techniques provides operative power for the entire mechanism of apparatus 20. In addition, a compressed air cylinder 58 is supported within the interior of body 21 and is operatively coupled to a battery-powered air compressor 60 and a spray control 57. Compressor 60 is operated under power from batteries 66 by conventional wiring (not shown) and provides a compressed air supply to air cylinder 58. The output of air cylinder 58 is operatively coupled by means not shown but in accordance with conventional fabrication techniques to spray controller 57. A plurality of output lines 59 are coupled to a sprayer 30. Sprayer 30 may utilize virtually any air driven paint or marking material sprayer having suitable flow capacity and characteristics. It has been found opportune to utilize a sprayer manufactured by Dell Marking Systems Inc., and sold under the trademark Macro-Mini Marker model DS20. However, it will be apparent to those skilled in the art that a variety of sprayers may be utilized to perform the essential function of directing a spray of paint or other suitable marking material downwardly under control of spray control 57.

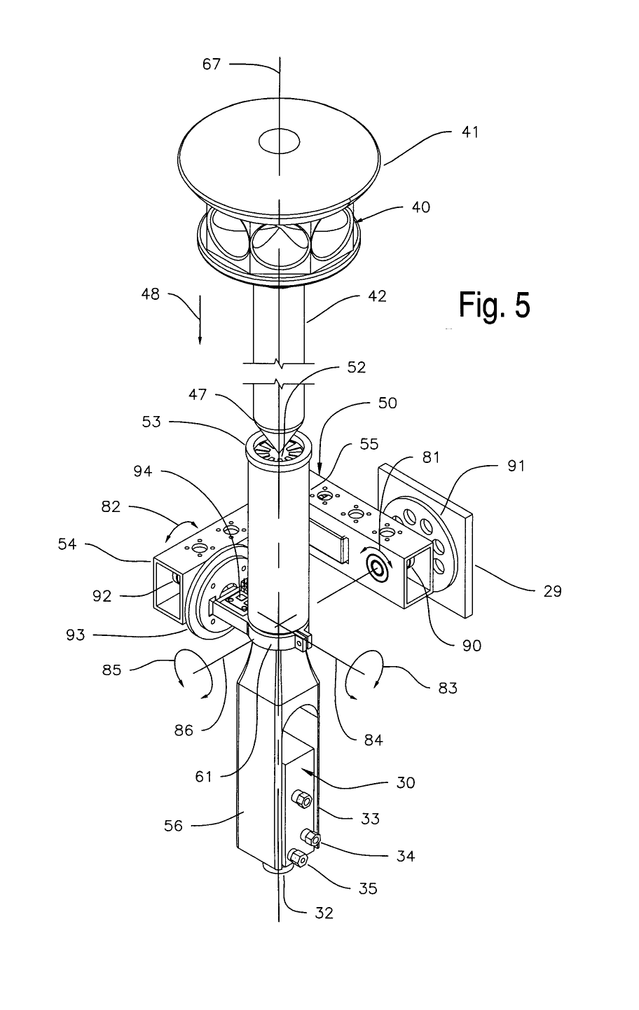

Apparatus 20 further includes an electronic gimble apparatus 50 which is secured within body 21 to provide a gimbled attachment to a staff receptacle 55 and a sprayer 56. Staff receptacle 55 and sprayer yoke 56 are physically joined in an axial alignment and are secured to the gimbled support of gimble 50. While it will be recognized that a plurality of gimbles suitable for supporting receptacle 55 and sprayer yoke 56 in a vertical orientation are available in the art. It has been found advantageous to utilize a digital gimble servo motor controlled gimble assembly manufactured by Robotzone, LLC which utilizes a pair of rotational supports operative on two different axes to maintain a vertical orientation for staff receptacle 55 and sprayer yoke 56. The structure of gimble 50 is set forth below in FIG. 5 in greater detail. However, suffice it to note here that the combination of sprayer yoke 56 and staff receptacle 55 are maintained in a vertical orientation through the operation of gimble 50. Accordingly, a gimble controller 57 is supported within the interior of body 21 and is operatively coupled to the sensing apparatus and servo motor controls within gimble 50 by conventional wiring (not shown). In further accordance with the present invention, sprayer yoke 56 receives and supports sprayer 30 in a downwardly facing orientation such that sprayer 30 produces a downwardly directed spray. In further accordance with the present invention, staff 42 of prism poll 40 supports PDA 76 and is received within staff receptacle 55 in the manner set forth below in FIG. 5. Of importance to note here is the direct alignment between the spray output of sprayer 30, sprayer yoke 56, staff receptacle 55, and staff 42 of prism poll 40. This direct axial alignment ensures the operation of gimble 50 in maintaining a vertical orientation of staff receptacle 55 and sprayer yoke 56 also results in ensuring that the output spray nozzle of sprayer 30 and prism reflection unit 41 of prism poll 40 are in accurate vertical alignment. This results in further ensuring that the positional information resulting from the interaction of prism poll 40 and base unit 12 (seen in FIG. 1) produces a correspondingly accurate position for sprayer 30. This in turn ensures that the marking spray applied to the host concrete surface is marked in direct alignment and correspondence to the position of prism reflection unit 41 of prism poll 40.

FIG. 5 sets forth a perspective view of gimble 50, staff receptacle 55, sprayer yoke 56, sprayer 30 and prism poll 40. For purposes of illustration, the surrounding elements of apparatus 20 are not shown in FIG. 5. However, it will be noted that the wall portion shown in FIG. 5 corresponds to the front wall of body 21 formed on the interior surface of front portion 22 (seen in FIG. 4). For purposes of illustration, the portion of body 21 to which gimble 50 is secured is indicated as a wall portion 29. However, it will be apparent from return to FIG. 4 that gimble 50 may be secured to any convenient position or wall surface within body 21 without departing from the spirit and scope of the present invention.

More specifically, gimble 50 includes a generally L-shaped frame 54 having a first servo 90 supported within one end of frame 54 includes a servomotor having an output shaft (not shown) coupled to a plate 91. Plate 91 is secured to wall portion 29 of apparatus body 21 utilizing fastener attachment or other convenient attachment and in accordance with conventional fabrication techniques. With plate 91 secured to wall portion 29, the remaining apparatus which forms gimble 50 is supported without additional attachment to a supporting wall or surface. Gimble 50 further includes a second servo 92 having a servomotor supported within frame 54 which in turn includes an output shaft (not shown) coupled to an output plate 93. Plate 93 in turn supports an extending band 61.

As mentioned above, staff receptacle 55 and sprayer yoke 56 are joined in accordance with conventional fabrication techniques in axial alignment. Thus, band 61 is secured to staff receptacle 55 and sprayer yoke 56 in a secure rigid attachment. Sprayer yoke 56 supports sprayer 30 which includes a downwardly extending spray nozzle 32 and a plurality of material and air couplings 33, 34 and 35. Couplings 33 through 35 are utilized in coupling sprayer 30 to spray controller 57 (seen in FIG. 4). Staff receptacle 55 comprises a generally cylindrical rigid member joined to sprayer yoke 56 and extending upwardly from band 61. Staff receptacle 55 defines an upwardly open interior bore 52. The upper entrance of bore 52 supports a friction element having a plurality of flexible inwardly extending shims 53.

In further accordance with the present invention, receptacle 55 receives the lower end of staff 42 of prism poll 40. Staff 42 defines a conical lower end 47 and further supports prism reflection unit 41 at its upper end.

In accordance with an important aspect of the present, the lower end of staff 42 is received within staff receptacle 55 by forcing it downwardly in the direction indicated by arrow 48. This downward movement of the lower end of staff 42 flexes shims 53 outwardly against the interior wall of bore 52. Shims 53 provide secure tight attachment between receptacle 55 and the lower end of staff 42. In addition, shims 53 cooperate to precisely center and position staff 42 within respect to the axis of staff receptacle 55. In this manner, prism reflection unit 41 of prism poll 40 and staff 42 are maintained in alignment with the axis of staff receptacle 55, sprayer yoke 56 and sprayer 30. For purposes of illustration, this axis is shown and referenced as axis 67. Once again, it must be understood that the importance of this alignment is the accurate positioning of spray nozzle 32 of sprayer 30 in vertical alignment with prism reflection unit 41. This ensures that the position information communicated within the positioning system is equally applicable of the position of spray nozzle 32. This in turn ensures accurate placement of sprayed marking elements produced when the system operates upon a concrete floor or the like.

In operation, gimble controller 51 (seen in FIG. 4) receives signals indicating the attitude of frame 54 from a two axis attitude sensor 94. Sensor 94 provides attitude information to gimble controller 51. In response, gimble controller 51 communicates operative signals to servos 90 and 92 within the objective of maintaining vertical axis 67 of sprayer yoke 56 and staff receptacle 55 in a predetermined vertical orientation.

More specifically, in response to orientation signals provided by gimble controller 51, servo 90 is operative to rotate frame 54 about axis 86 in the manner indicated by arrows 81. This rotation in turn produces rotation of sprayer yoke 56 and receptacle 55 about axis 86 in the manner indicated by arrows 85. Additionally, signals from attitude sensor 94 processed by gimble controller 51 are also applied to servo 92. Servo 92 is operative to rotate plate 93 about axis 84 in the directions indicated by arrows 82. This in turn rotates band 61 and the combination of sprayer yoke 56 and staff receptacle 55 about axis 84 in the directions indicated by arrows 83. The combined action of servos 90 and 92 produces two directional rotation of the combination of sprayer 30, sprayer yoke 56, staff receptacle 55 and staff 42 in both directions to maintain axis 67 in a vertical orientation perpendicular to the supporting surface upon which apparatus 20 is operating.

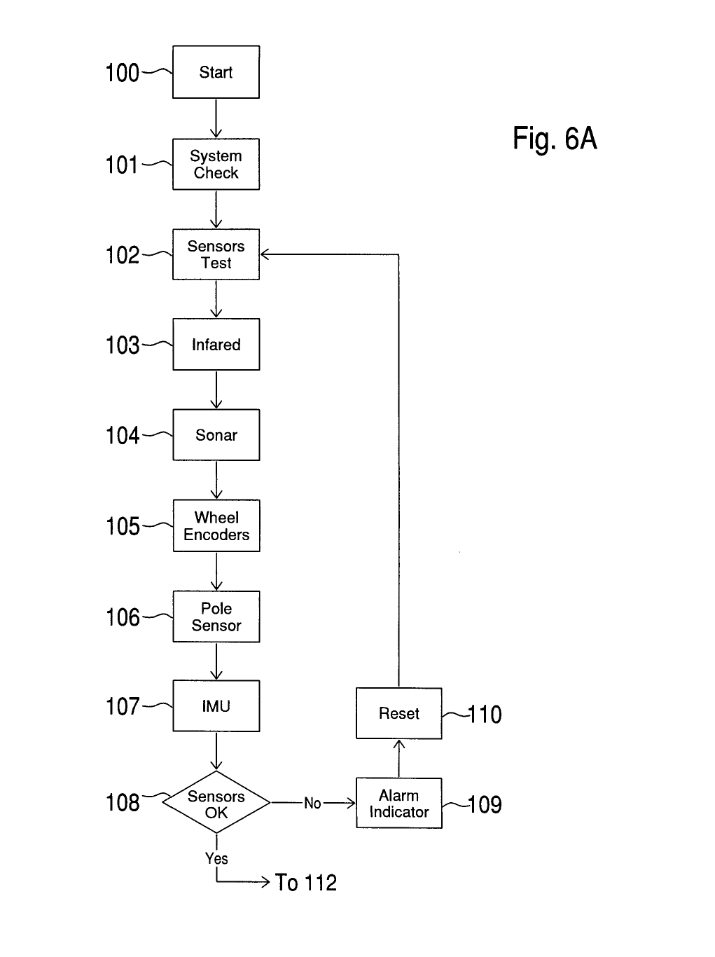

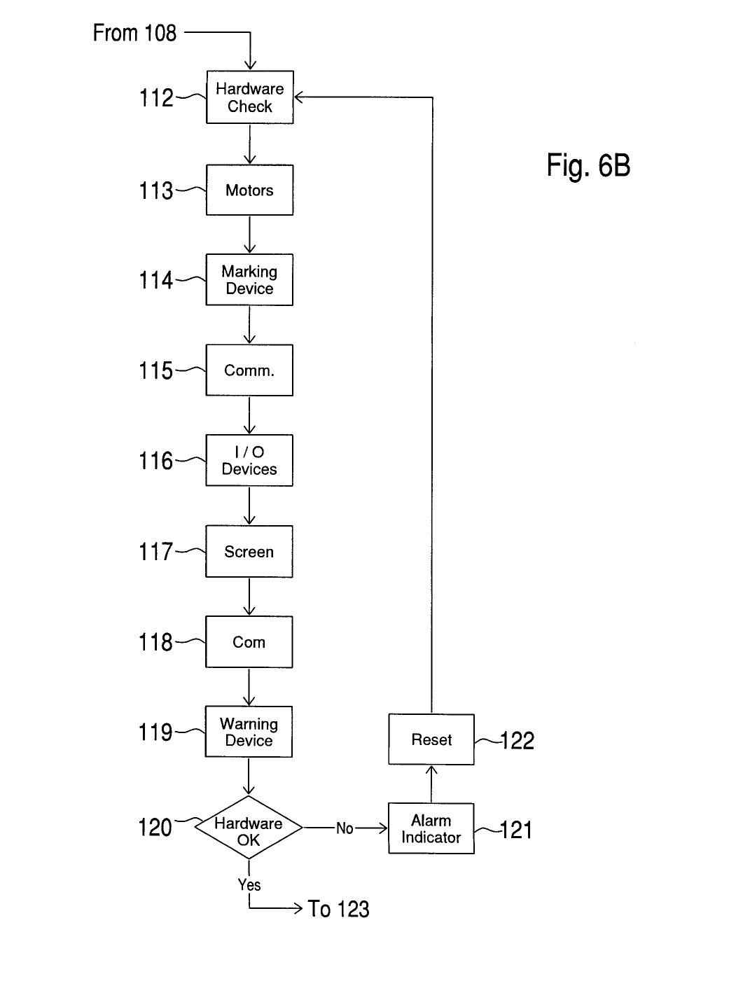

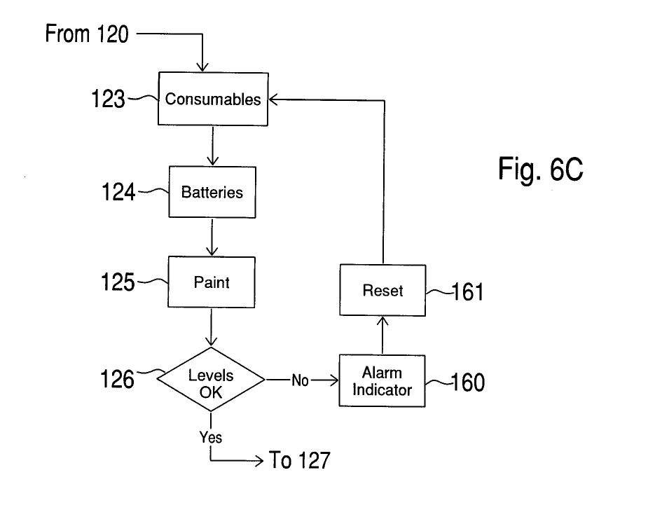

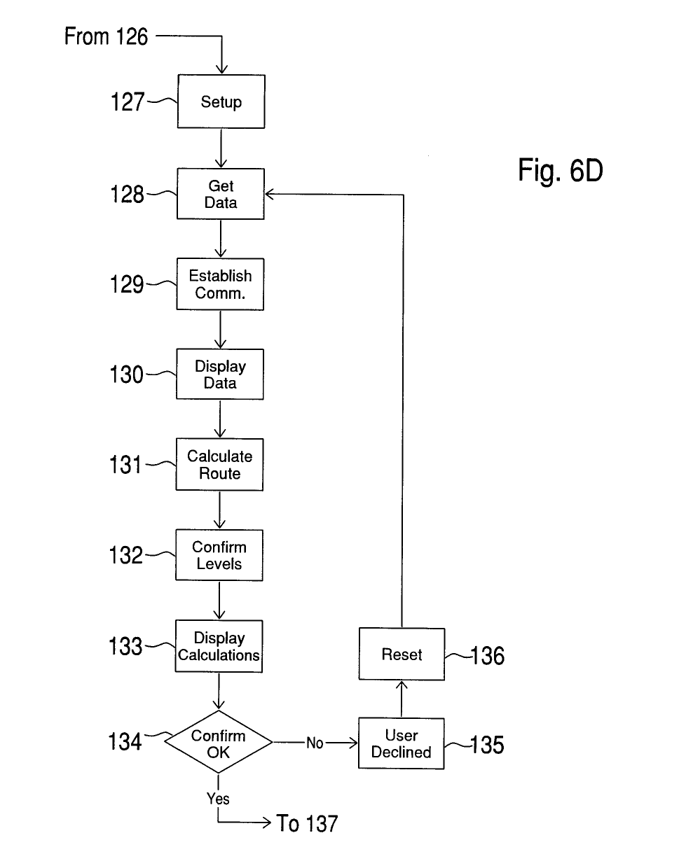

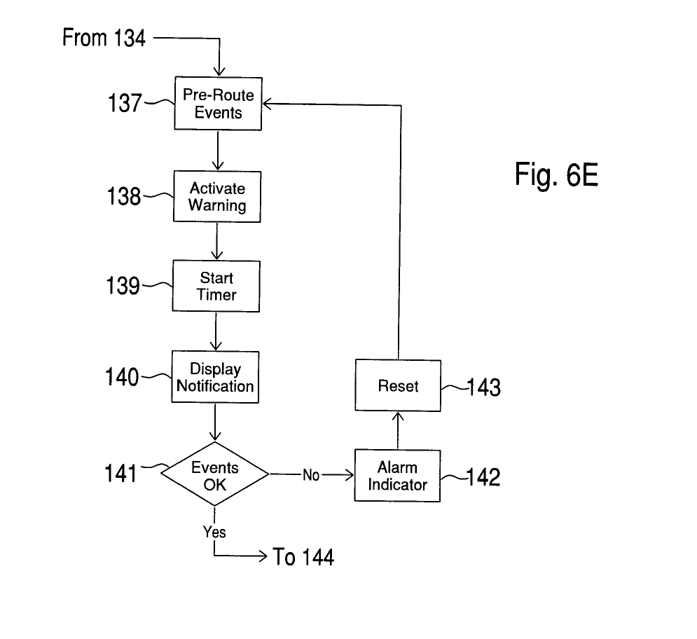

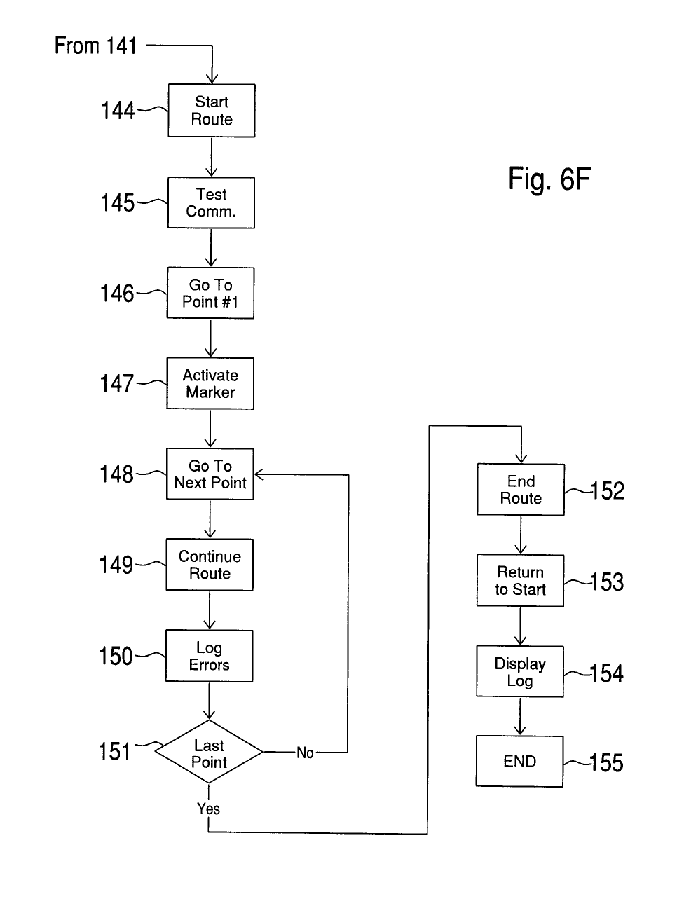

FIG. 6 sets forth an operational flow diagram of the present invention robotic construction site working apparatus. In the flow diagram set forth in FIG. 6, the inventive system is assumed to be operating utilizing one of the above-mentioned operating systems such as the TRIMBLE MEP system. Thus in accordance with the present invention and as is described above, the inventive system utilizes robotic marker 20 (seen in FIGS. 1 through 5) to host and support the prism (prism pole 40) upon the robotic system together with means supporting the combination of the prism pole and the sprayer (sprayer 30). Once again, it will be emphasized that maintenance of the combination thus formed is maintained in a vertical orientation by a digital gimble system (gimble 50). As a result, robotic marker 20 is able to carry the location components of the system utilized together with a controlled sprayer with a precision that ensures that the position information provided to and received from the robotic unit via the prism pole is directly equivalent to the location of the spray nozzle of the spray element. This vertical orientation is essential for precision of the marking process. As a result, the robotic system is able to carry the location and spray apparatus of the marker system with precision upon the host surface which is being marked. It will be recognized that while the above-described TRIMBLE MEP system is utilized in the illustrations set forth in FIG. 1 through 5, other alternative systems may be employed with the essential feature being the combination of a base unit to be supported in a reference point manner and a location and communication device which is mobile and carried to provide reference information as to its location upon the host surface.

More specifically, FIG. 6 sets forth the operative system which begins at a start step 100 and moves initially to a system check 101. System check 101 initiates a plurality of testing functions prior to operation of the system. Thus, following the initiation of the sensor test portion of system operation, the system moves to step 103 testing the infrared communication apparatus afterwhich the system moves to step 104 testing the sonar sensor apparatus thereafter moving to step 105 testing the encoders and thereafter moving to step 106 testing the pole sensor. Following step 106, the system moves to a final sensor test at step 107 in which the IMU sensor is tested. Following the sequence of sensor test steps 103 through 107, the system moves to a decision step in which a determination is made as to whether any sensor test was unsuccessful. In the event an unsuccessful sensor test is indicated, the system moves to an alarm indication step 109 and thereafter to a reset step 110. The system then waits for reset afterwhich the system returns to sensor test initiation 102 and repeats the sequence of steps until an indication is given at step 108 that all sensor tests are successful. Under this condition, the system moves the initiation of a hardware check at step 112. Following step 112, the system moves to step 113 performing a motor condition check afterwhich the system moves to a check of the paint sprayer at step 114 followed by a check of the communications system at step 115. Thereafter, the system checks the input/output devices at step 116 and thereafter checks the touch screen hardware at step 117. Following step 117 and its test of the touch screen hardware, the system performs a check of the communication hardware at step 118 and finally moves to a step 119 at which a check of warning devices is performed. Following step 119, the system moves to a determination at step 120 as to whether all hardware checks in steps 113 through 119 were successful. In the event a determination is made at step 120 that all hardware checks were not successful, the system moves to alarm step 121 and thereafter to reset step 122. Following the initiation of reset at step 122, the system returns to hardware check step 112 and repeats steps 113 through 119. Once a determination is made at step 120 that all hardware check steps have been successful, the system moves to step 123 which initiates the check of the status of consumables onboard the robotic marker. Following step 123, the system checks battery charge levels at step 124 and paint supply levels at step 125. In the event both levels checked in steps 124 and 125 are not successful, the system moves from step 126 to alarm step 160. Thereafter, the system moves to reset step 161. Once reset is initiated, the system returns to step 123 and recycles through steps 124 and 125 until an indication is given at step 126 that all consumables are available.

Once the system checks performed in steps 102 through 126 have been successful, the system moves to initiate a setup routine at step 127. At step 127, the setup routine or initialization of the operative system is carried forward. Following the entrance of the setup routine at step 127, the system moves to step 128 in which point data information is retrieved from the base unit. Thus, following step 128, the system moves to step 129 establishing communications with the RTS afterwhich the system displays data for user selection at step 130. Display of data is carried forward by display upon control panel 23 (seen in FIG. 2). Thereafter, the system calculates the most efficient route to perform the communicated marking process at step 131. Once the efficient route is calculate at step 131, the system performs a confirmation check of consumable material levels in view of the extent of marking required by the calculate route at step 132. As a final point data determination, at step 133 the system display the calculated results for confirmation and/or modification of the data. The system then moves to a step 134 in which a determination is made as to whether all initial data file reception and calculation as well as confirmation of consumables has been successful. In the event a problem is detected, the system moves to an alarm step 135 afterwhich it moves to a reset step 136. Following reset step 136, the system returns to step 128 and again carries forward steps 129 through 133 until a determination is made that all point data files and calculations are confirmed. Following this determination at step 134, the system moves to step 137 in which a sequence of pre-route events are carried forward. Following step 137, one or more of the robotic markers warning lights are activated at step 138 and, at step 139, a timer countdown is initiated. The length of this countdown is, to some extent, an operational preference or design condition. It has been found convenient to use a sixty second countdown. Once the sixty second countdown has been initiated at step 139, the system displays notice to the environment and the operator to clear the operative area at step 140. Following the successful initiation of steps 138 through 140, the system moves to step 141 in which a determination is made as to whether steps 138 through 140 have been carried forward successfully. In the event a problem is determined in the implementation of steps 138 through 140, the system moves to an alarm step 142 and thereafter to a reset step 143. Following reset at step 143, the system returns to step 137 and again cycles through steps 138 through 140.

Following successful implementation of steps 138 through 140 as indicated at step 141, the system moves to initiate its start routine at step 144. The start routine initiated at step 144 performs an RTS test at step 145, and thereafter moves to step 146 in which the robotic marker is commanded to move to the first reference point. Once location at first reference point is confirmed, the system moves to step 147 in which the sprayer is activated. In some instances, a sprayer activation will not be required at a given reference point. Following step 147, the system then commands the robotic unit at step 148 to proceed to the next reference point location. At step 149, the location at the next reference point is confirmed and the sprayer unit is again activated (if required) at step 149. Thereafter at step 150, the system logs any errors or problems encountered in moving to and between the reference points. At step 151, a determination is made as to whether the reference point at step 148 was the final reference point in the point data files. In the event the reference point at step 148 is not the final reference point of the routine, the system returns to step 148 and commands the robotic marker to move to the next reference point. Thereafter, the system moves again through steps 149 and 150 continuing to cycle therethrough until a determination is made at step 151 that the last reference point has been processed.

Following the determination at step 151 that all data point have been processed, the system moves to an end routine 152. At steps 153, the robotic marker is commanded to return to the starting point and, at step 154, the marking routine results are display and the information derived during the marking routine is logged in. Thereafter, the system reaches the end of the operative cycle at step 155 and ceases further operation until a start command is initiated again at step 100.

What has been shown is a novel robotic construction site marking apparatus which cooperates with a suitable location and positioning apparatus having a base unit and a movable handheld position detecting apparatus. The inventive system provides means for supporting and carrying the mobile portion of the host system upon the surface of a construction site such as a concrete floor. The system provides a cooperating gimble support for the location apparatus and a controlled sprayer for marking the host surface under the control of communicated reference point information. A robotic construction site marking apparatus includes a self-propelled robotic marker which carries the mobile location element and the marking sprayer under data control of the base system. The accuracy of spray marking location is ensured by the accurate gimble support of the sprayer and the sensing portion of the mobile positioning unit in an aligned vertical orientation.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. A robotic apparatus for construction site marking upon a floor surface, said robotic apparatus comprising:
a base unit positionable at a reference point upon a floor surface having means for storing site layout information, location means and communication means;
a movable position locator cooperating with said base unit in communication therewith;
a robotic marker having a body, a plurality of drive wheels and a drive controller for operating said drive wheel to move said robotic marker upon a floor surface;
a receptacle receiving a portion of said position locator;
spray means having a sprayer and a spray nozzle; and
a gimble support supporting said position locator and said sprayer such that said position locator and said spray nozzle are aligned along a common vertical axis,
said base unit and said position locator cooperating to direct said robotic marker to move to one or more reference points upon a floor surface and to mark a floor at said one or more reference points by activating said sprayer.

2. The robotic apparatus set forth in claim 1 wherein said sprayer and said spray nozzle are supported in a common sprayer unit.

3. The robotic apparatus set forth in claim 2 further including a sprayer yoke joined to said receptacle supporting said sprayer unit, said gimble support being operative to move and orient said receptacle, said position locator, said sprayer yoke and said sprayer unit into a vertical alignment.

4. The robotic apparatus set forth in claim 3 wherein said position locator includes a prism reflection unit interacting with said base unit and a staff joined to and supporting said prism reflection unit, said staff having a lower end received within said receptacle.

5. The robotic apparatus sets forth in claim 4 wherein said drive wheels each include an operatively coupled drive motor and wherein said drive controller provides differential drive control to said drive motors to locomote and steer said robotic apparatus.

6. The robotic apparatus set forth in claim 5 wherein said gimble support includes:
a gimble frame;
a first servo supported by said gimble frame having a first output plate secured to said body; and
a second servo supported by said gimble frame having a second output plate joined to said receptacle,
said gimble frame supporting said first and second servos such that they rotate their respective first and second output plates about respective first and second perpendicular co-planar axes.

7. The robotic apparatus set forth in claim 6 wherein said gimble frame defines a generally L-shaped member having first and second ends supporting said first and second servos respectively.

8. A robotic apparatus for construction site marking comprising:
a body defining an interior cavity and a top surface, said top surface defining an aperture therein;
a battery power supply supported by said body;
a compressed air supply supported by said body;
a spray controller supported by said body;
a pair of drive wheels supporting said body each having a drive motor and a differential drive controller operating said drive motors;
a paint sprayer having a spray nozzle;
a staff receptacle for receiving and supporting a prism pole;
a sprayer yoke joined to said staff receptacle, supporting said sprayer such that said spray nozzle is downwardly directed; and
a gimble support coupled to said body and said staff receptacle operative to maintain said staff receptacle and said spray nozzle in vertical alignment.
